(19) United States
(12) Patent Application Publication
(10) Pub. No.: US 2015/0042502 A1
(43) Pub. Date: Feb. 12, 2015

(54) ELECTROMAGNETIC RADIATION ATTENUATOR

(71) Applicant: MICROMAG 2000, S.L., Madrid (ES)

(72) Inventors: Ainhoa Gorriti González, Madrid (ES); Daniel Cortina Blanco, Madrid (ES); María De La Sierra Flores, Madrid (ES); Javier Calvo Robledo, Madrid (ES); Juan José Gómez Robledo, Madrid (ES); Pilar Marín Palacios, Madrid (ES); Antonio Hernando Grande, Madrid (ES)

(73) Assignee: MICROMAG 2000, S.L., Madrid (ES)

(21) Appl. No.: 14/388,378

(22) PCT Filed: Mar. 26, 2013
(86) PCT No.: PCT/ES2013/070201

§ 371 Date: Sep. 26, 2014

(30) Foreign Application Priority Data
Mar. 30, 2012 (EP) 12382128.2

(51) Int. Cl. H01Q 17/00

(52) U.S. Cl. CPC H01Q 17/00
USPC 342/1; 427/9

(57) ABSTRACT

The invention relates to a material configured such as to include a plurality of layers, some layers being made of a composite material and some layers being made of a dielectric material. The layers of composite material include a mixture of host dielectric material and inclusions, such that said inclusions are embedded in the structure of the host dielectric material. Said inclusions preferably include highly conductive fibres, specifically metal microwires. Thus, the structure of the material according to the invention includes a plurality of layers, some layers being made of a composite material, which includes a host dielectric material with inclusions, and some layers being made of a dielectric material. The structure of the material according to the invention is designed so that the surface on which said material is applied is capable of absorbing a portion of the incident electromagnetic radiation, thus substantially reducing the electromagnetic radiation reflected by same curved.

### FIELD OF THE INVENTION

The present invention relates to a material designed for the reduction of the reflection of electromagnetic (EM) radiation from a structure covered with such a material, to a method of configuring the cited material and to the use of such a material.

### BACKGROUND OF THE INVENTION

At present, there are a wide number of applications requiring the reduction of the reflection of electromagnetic radiation (EM), also known as Radar Cross Section (RCS) or radar signature, from structures or objects. For example, in defence applications, the structures of crafts such as ships or airplanes, and of missiles require the mentioned reduction of electromagnetic radiation, so as not to be detected by enemy radars. Furthermore, in civil applications, the reduction of electromagnetic radiation is very useful to avoid EM clutter in weather and navigation radars, for structures such as wind turbines or airport structures. It is known that electronic systems give rise to electromagnetic interferences (EMI), interferences in radars and low efficiency in systems due to their coupling, so the isolation of antennae and apparatuses having a high EM radiation output or of those apparatuses that can be affected by EM radiation, such as imaging equipment for medical applications, is also a wide field of application requiring the reduction of electromagnetic radiation.

In summary, there exist two main fields of application for the reduction of the electromagnetic radiation:
a) reducing the radar cross section (RCS) of large structures, so that they are not detectable by radars, for “invisibility” purposes, warfare applications and for better functioning of civil radars (navigation and weather radars); and
b) minimizing electromagnetic interferences (EMI) between electronic systems, antennae crosstalk, interference of mobile phones with other equipment, radiation generated by other equipment, etc.

Microwave absorbers are materials, known in the state of the art, absorbing part of the electromagnetic radiation incident on them, in such a way that the reflected radiation is reduced. The known existing microwave absorbers are mainly based on magnetic losses or on traditional Salisbury screens. Those absorbers based on magnetic losses can produce wideband absorption but they need thick layers and therefore pose a high add on weight. Furthermore, traditional Salisbury screen, though being of narrow band and light, have the problem of being thick and very fragile.

A Radar Absorbing Material (RAM) or attenuator of the reflection of electromagnetic radiation, as well as a method for controlling the spectrum thereof, is known from document WO 2010/029193 A1. In this document, an attenuator comprising two layers located onto a metallic sheet is disclosed, the first layer comprising a dielectric material and being situated over the metallic sheet, and the second layer comprising a dielectric material and non-magnetic highly conducting fibres, such that this second layer is situated over the first layer. By acting on the impedances of the different layers, it is possible to control the spectrum of this attenuator. However, further research and experimentation has led to the need of expanding the limitations of the parameters described for the layered structure to accommodate it for multiband absorption. Furthermore, it has been found necessary to broaden the non-magnetic highly conducting fibres to other types of fibres, such as, for example, magnetic ones.

It is also known in the state of the art document EP 11382066.6 disclosing a paint composition comprising conductive fibres such that, when this paint is applied onto a certain material, the reflected electromagnetic radiation is reduced compared to the electromagnetic radiation incident on this material. This paint composition has a particular dielectric constant such that the above-mentioned reduction is possible. However, it would be advantageous to broaden the family of dielectric materials that can be used in the composite, to use different types of paint, to be able to use different materials such as glass reinforced materials or fibreglass (GR), such as GRE and GRP, or polyethylene. Thus, as different materials are used, this comes along with the need of modifying the fabrication process depending on the composite material used, and also of modifying accordingly the application process for each different composite material used.

It is known from document US 2009/0075068 A1 flake inclusions (metal or ferrite) with a high mass fraction, in a composite onto a shielding of EM waves, applied to communications cables to reduce noise between communication devices. The total layer thickness is between 17 and 70 mm. However, this structure has a high mass fraction, and it cannot be implemented into a thin layer structure. Furthermore, it cannot be tuned for several frequency bands.

Document WO 93/22774 discloses a mixture of polymeric or liquid matrix material and a combination of conductive powders, fibres and optional flake component, with: 1 to 10% of one or more conductive fibres, 10 to 60% of one or more conductive metal powder, 0 to 35% of conductive metal flake material, 0 to 25% of organic compound, fibre length from 0.1 to 0.5 inches (2.5-13 mm), diameter of about 3-15 microns and sheets of composite of ⅛ inches (3.2 mm) with broad band shielding properties. However, this structure cannot be implemented into a thin layer structure. Furthermore, it cannot be tuned for several frequency bands.

Document GB 2450593 A of the prior art discloses an optical multiplexer to receive and transmit optical signal via fibre optic cables. They have an electrically conductive paint, polymer or adhesive covering at least portions of one of the external surfaces. Conductivity is selected to shield EMI, EMP or ESD. The document discloses paint, polymer, elastomer or adhesive loaded with at least one type of the following electrically conductive particles: carbon fibres, flakes and particles, carbon black, graphite, nanoparticles, metal beads, flakes or particles, and metal, glass or ceramic beads, flakes or particles coated with metal such as silver, copper, nickel, tin, zinc or aluminium. Again, this structure has a high mass fraction, and it cannot be implemented into a thin layer structure. Furthermore, it cannot be tuned for several frequency bands.

Document EP 1675217 A1 of the same applicant discloses a structure comprising three layers: Dielectric, Composite, Dielectric. The frequencies attenuated are between 0.5 and 20 GHz, in single band absorption. However, this structure cannot be readily applied for attenuating in a broader frequency range, neither can it be tuned for a variety of frequency bands.

It is known in the state of the art, as per document U.S. Pat. No. 5,085,931 A a structure having as inclusions: acicular magnetic metallic filaments length<10 mm, aspect ratios (length/diameter) between 10:1 and 50:1, with volume fraction that may be lower than 35%. Resulting paint is formed by dissolving the absorber (dielectric binder+inclusions). These inclusions may be magnetic or not, however, their magnetic behaviour does not impact the absorption properties. Besides, it cannot be properly implemented into a thin layer structure.

Document US 2002/2046846 A1 in the prior art discloses shields for EMI for access panels and doors in electronic equipment enclosures, with electrically non conductive substrate in combination with an electrically conductive element. This structure has four aspects: substrate+conductive layer, metal wool+foamable mixture, polyol+isocyonate+conductive particles (metal particles, conductive polymers . . . ), polymeric fibre fabric+electrolessly plated. However, this document relates to the manufacturing of a layer of material that is highly conductive but can also be shaped for door or panels in electronic equipment enclosures, therefore, any GHz wave will be highly reflected by the surface, not attenuated.

It is known in the state of the art, for example as per the article “Multiband electromagnetic wave absorber based on reactive impedance ground planes” of F. Costa and A. Monorchio, a structure comprising a single resistive sheet mounted at a fixed distance from a composite layer acting as a reactive surface, responding as an electric conductor at high frequencies and as an absorber at low frequencies. However, the structure presented in this document cannot be implemented into a thin structure layer, nor is it easy to be applied to different structures and objects.

The article “Multiband terahertz metamaterial absorber” published in Chinese Physics B, Vol. 20, No 1 (2011) discloses a material acting as absorber in a multiband region; however, this is a complex material that cannot be implemented into big surfaces nor is it designed to absorb GHz.

“Microwave absorption characteristics of carbon nanotubes” published by Nanchang University, Sun Nanotech Co Ltd describes the use of carbon nanotubes in composite materials for microwave absorption; however, this technique uses a high mass fraction of particles, and the films used are thicker than the ones presented in this application for the same attenuating frequency. Moreover, they absorb at a single frequency band.

Also known per the state of the art is “Design of a Salisbury screen absorber using frequency selective surfaces to improve bandwidth and angular stability performance” of F. Che Seman, R. Cahill, V. F. Fusco and G. Goussetis, showing an improved design of a known Salisbury screen with an improved angular stability and improved reflectivity bandwidth. However, the material presented in this document is complex and not easy to apply on large surfaces.

Some other documents in the state of the art show materials having other types of inclusions, such as ferrites or carbon fibres, for example. These structures have the advantages of having generally large bandwidths and being frequency tuneable. However, no multiband absorption can be obtained. Moreover, these structures present several disadvantages, such as high mass fractions, thick layers, which result in heavy materials, they also have high maintenance costs. A material that is able to reduce thickness and make wider band absorption is really desirable. Some of the documents showing this are, for example:
“Microwave absorption characteristics of carbon nanotubes” published by Nanchang University, Sun nanotech Co Ltd describing the use of carbon nanotubes in composite materials for microwave absorption; however, this technique uses a high mass fraction of particles, and the films used are thicker than the ones presented in this application for the same attenuating frequency. Moreover, they absorb at a single frequency band.
“Complex Permeability and Permittivity and Microwave Absorption of Ferrite-Rubber Composite in X-band Frequencies”, Kim et al. IEEE Trans. on Magnetics, Vol. 27, No. 6, 1991, disclosing composites with ferrites, monoband tuneable RAM composites, with large mass fractions and thicknesses.
“Complex Permeability and Permittivity and Microwave Absorption Property of Barium Ferriti/EPDM Rubber Radar Absorbing Materials in 2-18 GHz”, Yongbao et al. APMC 2005 Proceedings, disclosing composites with ferrites, monoband tuneable RAM composites, with large mass fractions and thicknesses.
“Microwave Absorbing Polymer Composites”, Murugan and Kokate. 2009 International Conference on Emerging Trends in Electronic and Photonic Devices & Systems, citing polymeric composite, highly efficient but very expensive and not upscalable.
“Enhanced electromagnetic wave absorption properties of Fe nanowires in gigahertz range”. Liu et al. Applied Physics Letters 91, 2007, showing

high mass fraction and thick layers.
“Electromagnetic Wave Absorption Properties of Amorphous Alloy-Ferrite-Epoxy Composite in Quasi-Microwave Band”. Lim et al. IEEE Trans. on Magnetics, Vol. 39, No. 3, 2003 disclosing high volume fractions and single band attenuation.

The present invention is intended to solve the above-mentioned disadvantages, providing a solution applicable to the cases mentioned below.

### SUMMARY OF THE INVENTION

According to a first aspect, the present invention provides a material configured in such a way that, when it is applied over a certain surface, it is able to substantially reduce the electromagnetic radiation reflected by this surface compared to the electromagnetic radiation incident on it.

The material of the invention is configured in such a way that it comprises a plurality of layers, some layers being made of composite material and some layers being made of dielectric material. The layers of composite material comprise a mixture of a dielectric host material and inclusions, such that these inclusions are embedded in the structure of the dielectric host material. Preferably, these inclusions comprise highly conductive fibres, more preferably metallic microwires. Thus, the structure of the material of the invention comprises a plurality of layers, some layers being made of composite material, comprising a dielectric host material with inclusions, and some layers being made of dielectric material. The structure of the material according to the invention is designed in such a way that the surface onto which it is applied, is able to absorb part of the incident electromagnetic radiation, therefore substantially reducing the electromagnetic radiation reflected by it. According to the invention, the dielectric material forming the dielectric layers and the dielectric host material in the composite can be a paint, a glass reinforced material, polyethylene, polyester or an elastomeric material, such as silicone.

Preferably, the composite material forming the material of the invention will be a paint component, configured in such a way that it will be applied to any surface structure, this surface being a metallic surface or a previously metallized surface. Furthermore, the material of the invention is tailored depending on the use and application for which it is required, therefore having a different structure and composition depending on the frequencies targeted to be attenuated on the structure onto which it is applied.

According to a second aspect, the invention provides a method for configuring a material able to reduce the electromagnetic radiation reflected by a surface when applied onto it. More specifically, the invention provides a method for configuring the electromagnetic properties of the composite material of some of the plurality of layers forming the material of the invention, such that the electromagnetic properties of such material can be modelled according to a theoretical model that will be further described. Besides, the invention provides a method for applying the plurality of layers of dielectric and composite material configuring the electromagnetic radiation (EM) attenuating material of the invention. The invention also provides a method for integrating the inclusions within the dielectric host material configuring the composite material in the EM radiation attenuating material of the invention.

As mentioned before, the EM radiation attenuating material is a multiple-layered structure of dielectric material and composite material. Depending on the targeted frequencies of attenuation, the structure of layers varies in number, thickness and positioning order of the dielectric material layers and of the composite material layers. Thus, for example, for a single band absorption, a three layer structure is needed in the EM radiation attenuating material, having a dielectric material layer, a composite material layer and a dielectric material layer (top coat as protective layer), in this order of positioning. A double band absorption can be obtained with at least four layers having different layer positioning when a thin structure is sought and the frequencies of maximum attenuation are not harmonics, plus a top coat acting as protective layer, or it can be obtained with only two layers by taking advantage of the occurrence of harmonics, in this case, the structures are thicker.

Furthermore, a third aspect of the present invention describes the use of such an EM radiation attenuating material.

### BRIEF DESCRIPTION OF DRAWINGS

The foregoing objects and many of the attendant advantages of this invention will become more readily appreciated as the same becomes better understood by reference to the following detailed description when taken in conjunction with the accompanying drawings, wherein:

FIG. 1 shows an embodiment of the configuration of an EM radiation attenuating material in the C band of frequencies, according to the present invention.

FIG. 2 shows an embodiment of the configuration of an EM radiation attenuating material in the X band of frequencies, according to the present invention.

FIG. 3 shows an embodiment of the configuration of an EM radiation attenuating material in the Ku band of frequencies, according to the present invention.

FIG. 4 shows an embodiment of the configuration of an EM radiation attenuating material having a single band absorption in the S band of frequencies, according to the present invention.

FIG. 5 shows an embodiment of the configuration of an EM radiation attenuating material having double band absorption in the X and Ku bands of frequencies, according to the present invention.

FIG. 6 shows an embodiment of the configuration of an EM radiation attenuating material having a single band absorption in the C and Ku bands of frequencies, according to the present invention.

FIG. 7 shows an embodiment of the configuration of an EM radiation attenuating material having double band absorption in the C and Ku bands of frequencies, according to the present invention.

FIG. 8 shows an embodiment of the configuration of an EM radiation attenuating material having double band absorption in the C and Ku bands of frequencies, according to the present invention.

FIG. 9 shows an embodiment of the configuration of an EM radiation attenuating material having double band absorption in the S and X bands of frequencies, according to the present invention.

FIG. 10 shows an embodiment of the configuration of an EM radiation attenuating material having triple band absorption in the C, X and Ku bands of frequencies, according to the present invention.

In all Figures mentioned above (FIGS. 1-10), the measurements effected, marked in continuous line, are compared to the theoretical model results, marked in dotted line. The reflectivity (in dB) is shown in the y axis and the frequency (in GHz) appears in the x axis.

FIG. 11 is a sectional view showing the configuration of an EM radiation attenuating material according to the present invention.

### DETAILED DESCRIPTION OF THE INVENTION

The present invention discloses an electromagnetic radiation attenuating material 10, also known as RAM material (Radar Absorbing Material) comprising a plurality of layers 20, such that at least one of the layers 21 comprises a dielectric material and at least one of the layers 22 comprises a composite material. Each of the composite material layers 22 comprises a mixture of a dielectric host material and inclusions, such that the inclusions are embedded in the dielectric host material. Preferably, the inclusions are highly conductive fibres. More preferably, these highly conductive fibres are microwires, though they can also be, for example, carbon nanofibres. The dielectric material of both the dielectric material layers 21 and of the composite material layers 22 (without the inclusions) will preferably be any type of paint (water or solvent based), glass reinforced materials, polyethylene, polyester or an elastomeric material, such as silicone. More preferably, the electromagnetic radiation attenuating material 10 will be configured as a paint component able to be applied onto any form of surface 30. The surface 30 onto which the EM radiation attenuating material 10 is applied can be of any sort; however, a metallic surface highly reflects the incident radiation 100 and the EM radiation attenuating material 10 needs a metallic reflector to work, so if the surface 30 is not metallic, a previous metallization is effected on it, preferably by means of a metallic paint.

The layers 20 configuring the structure of the EM radiation attenuating material 10 are tailored for attenuation in multiband, in S, C, X and Ku bands, though it is also possible to develop materials within applicable parameters in the whole GHz spectrum, in such a way that:

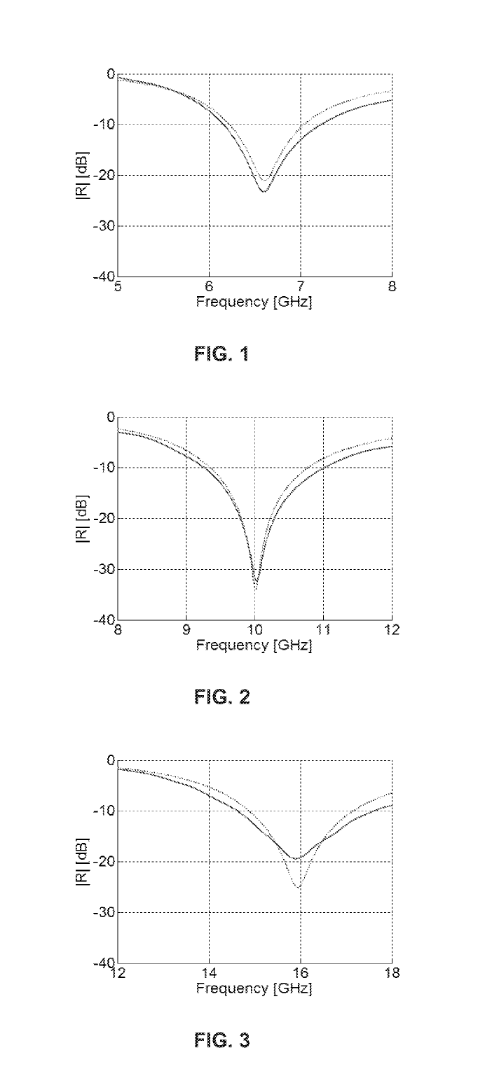

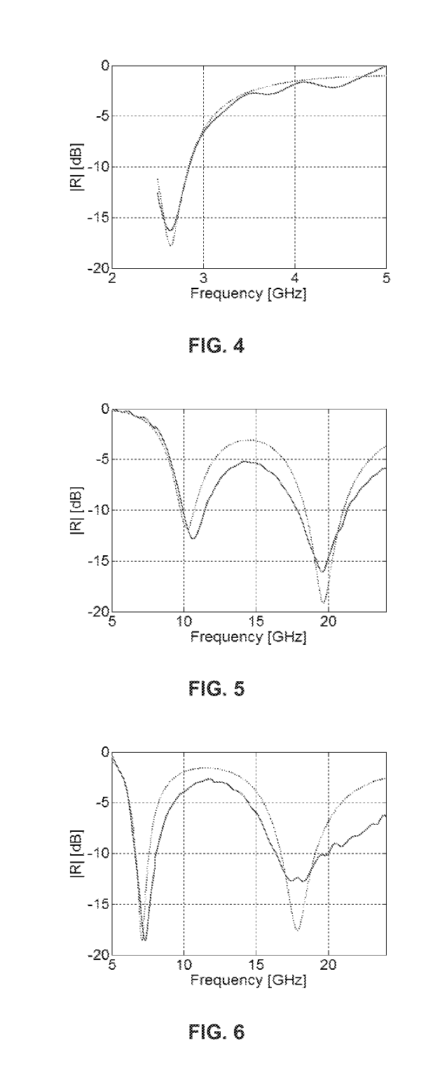

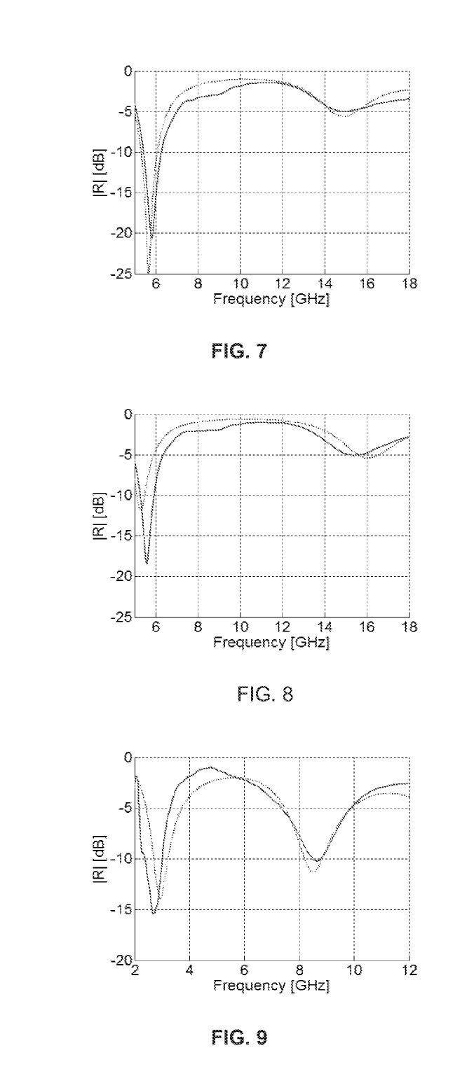

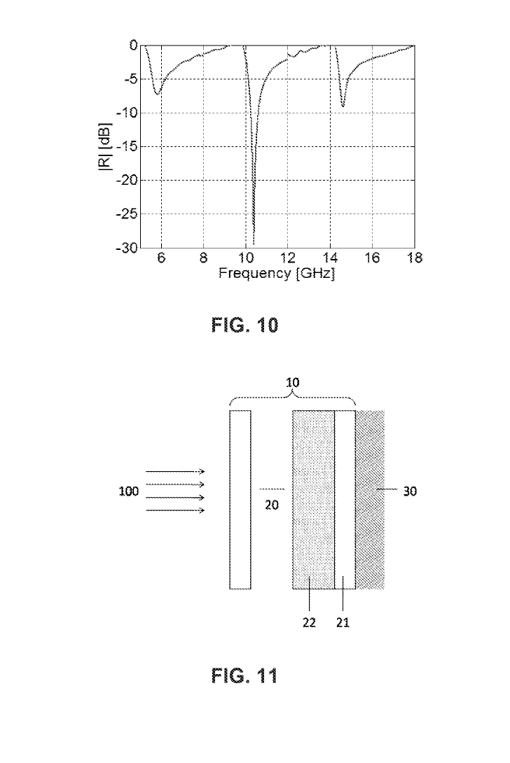

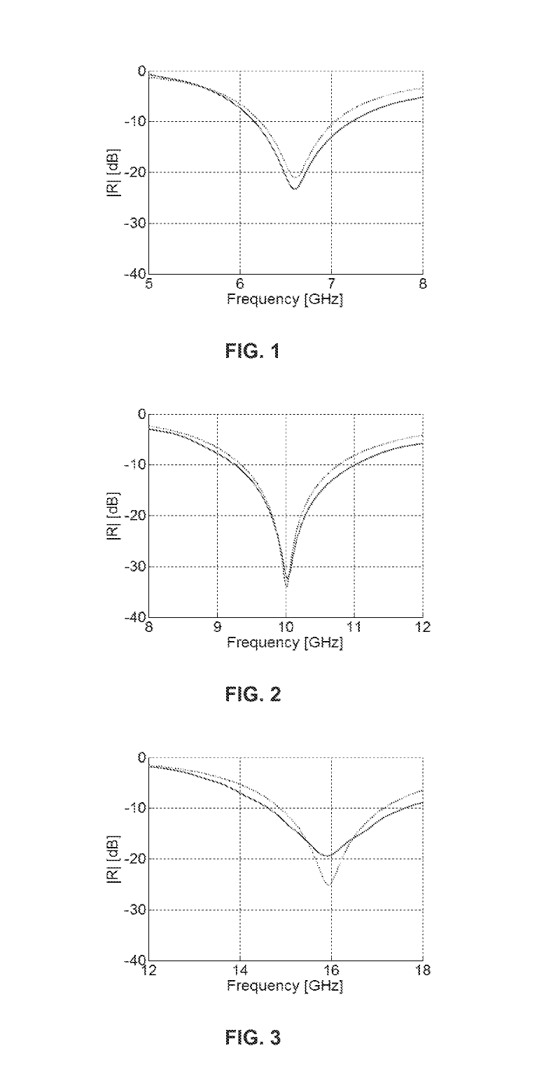

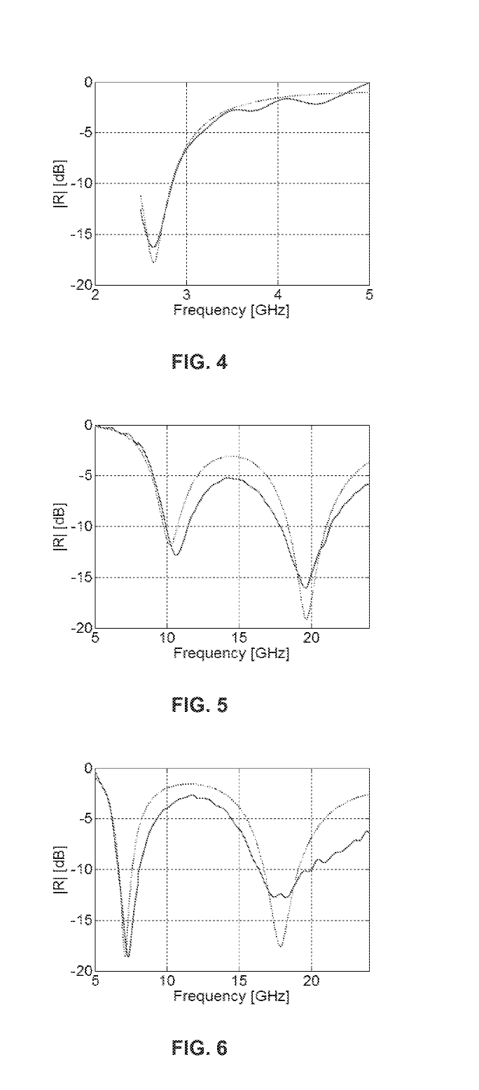

For obtaining a single band attenuation: a single frequency of maximum attenuation in one specific frequency band is sought. This can be obtained with an EM radiation attenuating material 10 having three layers 20, with the following positioning of said layers 20: dielectric material layer 21-composite material layer 22-dielectric material layer 21 (top coat as protective layer). The properties of the dielectric material used, the thickness of the first dielectric layer 21 and the thickness, aspect ratio and volume fraction of the inclusions (preferably microwires) of the composite, will determine the frequency of maximum attenuation, as already explained in document WO 2010/029193 A1, belonging to the same applicant. The third layer of dielectric material 21 is used as a protective and finishing layer, being in the order of hundreds of microns of thickness and having a low dielectric loss that does not influence the reflectivity spectrum. FIGS. 1, 2, 3 and 4 give examples of these embodiments of the EM radiation attenuating material 10, for the C, X, Ku and S bands, respectively, such that the dielectric material in FIGS. 1, 2 and 3 is paint and the dielectric material in FIG. 4 is a glass reinforced epoxy (GRE). Needless to say, whenever there is resonance in the reflectivity (absorption) at a certain frequency, harmonics of this resonance will present themselves at odd multiples of the electrical quarter wavelengths, so that more attenuation than that at two frequency bands is possible, but not tuneable to desired frequencies. Nonetheless it is possible to design EM radiation attenuating materials 10 that attenuate at two bands and that are not harmonics, as it will be further described.

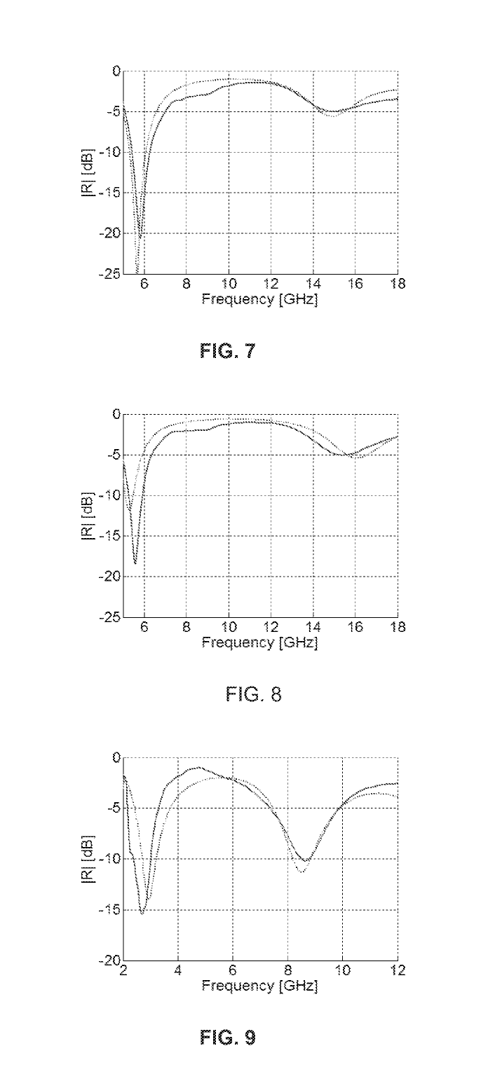

For obtaining a double band attenuation: two frequencies of maximum attenuation in one or more frequency bands are sought, such that the second attenuation is not necessarily a harmonic of the first. A possible embodiment for obtaining this comprises an EM radiation attenuating material 10 having at least four layers 20 plus a top coat (protective layer), with the following positioning of the cited layers 20: the first and last layer is always a dielectric material layer 21, while the inner layers can be either dielectric material layers 21, composite material layers 22 or a combination of both, 21 and 22. The thicknesses of all layers 20, except that of the last layer that is used as a protective and finishing layer, the aspect ratio and volume fraction of the inclusions (preferably microwires) in the composite material layers 22, as well as the dielectric properties of the dielectric material used, determine the frequency of maximum attenuation. This configuration of the EM radiation attenuating material 10 comprising at least five layers 20 is used for “thin” structures (2-3 mm), the frequencies are not harmonics and appear in close frequency bands (C-X, X-Ku). Examples showing this configuration are represented in FIG. 5 (five layers 20, Dielectric 21-Composite 22-Dielectric 21-Composite 22-Dielectric 21, DCDCD), FIG. 6 (five layers 20, DCDCD), FIG. 7 (seven layers 20, DCDCDCD), and FIG. 8 (seven layers 20, DCCCCD), showing different embodiments of double band absorption with paint as dielectric material.

Another possible embodiment aiming two frequencies of maximum attenuation in one or more frequency bands is shown in FIG. 9 (two layers 20, DC) with glass reinforced epoxy (GRE) as dielectric material. This embodiment comprises only two layers 20, one of the layers having a considerable thickness (6-7 mm), the frequencies being harmonics. This embodiment of two layers 20 can also be obtained using paint as the material of the layers 20, instead of using glass fibre reinforced epoxy (GRE) material.

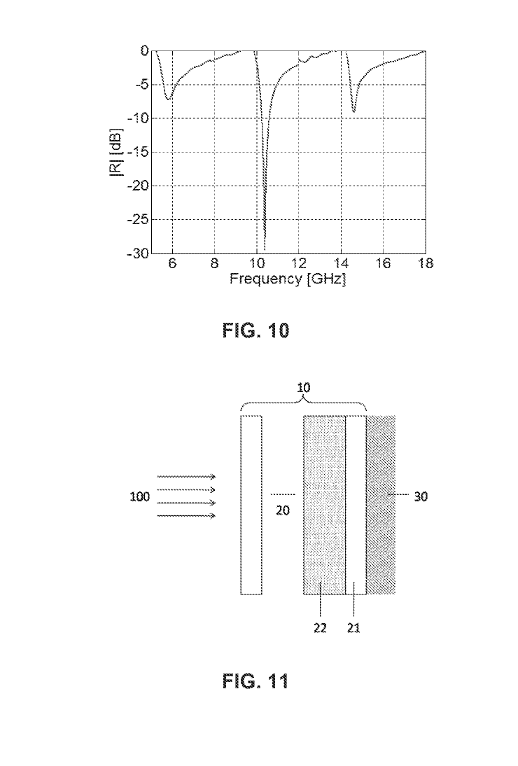

For obtaining multiband attenuation: multiple frequencies of maximum attenuation in one or more frequency bands are sought. FIG. 10 is an embodiment of such configuration, with polyethylene as dielectric material and with seven layers 20, in which the attenuation spectrum is effected in three frequency bands, C, X and Ku.

The composite material layer 22 is obtained by a special mixing process of the paint (the paint being the dielectric host material in the composite layer 22) and microwires (the microwires being the inclusions in the composite layer 22), such that the layer 22 is able to be applied as a normal paint, adding the appropriate amount of solvent required. When glass reinforced materials or polyethylene are used as dielectric host material in the composite layer 22, the mixing process also follows a specific procedure.

The tuning can be predicted by means of using the theoretical model described in document WO 2010/029193 A1, belonging to the same applicant. If the model described in WO 2010/029193 A1 is extended to n number of layers 20, such that the reflectivity of the n^{th} layer 20 is given by:

$$\text{?} = \frac{\text{?} + \text{?} \text{?}}{\text{?} + \text{?} \text{?} \text{?}}$$

$$\text{?} \text{indicates text missing or illegible when filed}$$

where rₙ is the local reflection coefficient of the n^{th} interface layer 20, γₙ₊₁ is the propagation constant at the section n+1 and dₙ₊₁ its thickness. The local reflection coefficient and the propagation constant are given by:

$$\text{?} = j \frac{\text{?} \text{?} f}{\text{?}} \sqrt{\text{?} \text{?}}$$

$$\text{?} = \frac{\sqrt{\frac{\text{?}}{\text{?}}} - \sqrt{\frac{\text{?}}{\text{?}}}}{\sqrt{\frac{\text{?}}{\text{?}}} + \sqrt{\frac{\text{?}}{\text{?}}}}$$

$$\text{?} \text{indicates text missing or illegible when filed}$$

where j=\sqrt{−1}, f is the frequency, cₒ is the speed of light in free space and ∈ₙ*; is the complex relative electrical permittivity of the n^{th} layer 20 and μₙ* is the complex relative magnetic permeability of the n^{th} layer 20.

The electromagnetic properties (permittivity and permeability) of each layer 20 of the EM radiation attenuating material 10 depend on whether they are dielectric material layers 21 or composite material layers 22. In the first case (dielectric material layers 21) the permittivity is the permittivity of such material, that is, of the dielectric material used, this permittivity being usually between 1 and 10, and the permeability is generally 1. For the composite material layers 22, with very high conductive inclusions (conductivity (σᵢ) comprised in the order of 10⁶ S/m) the permittivity can be computed using the model given in document WO 2010/029193 A1 of the applicant. For inclusions with not so high conductivities, such as, less conductive microwires or carbon nanofibres inclusions (σᵢ in the order of 10³-10⁴ S/m), the generalized expression for the effective permittivity, (∈_{eff}), of the composite, is given by:

$${ɛ}_{eff} = \text{?} + \frac{\frac{1}{3} {f}_{i} ( {ɛ}_{i} - \text{?} ) Σ \frac{\text{?}}{\text{?} + {N}_{i , j} ( {ɛ}_{i} - \text{?} )}}{1 - \frac{1}{3} {f}_{i} ( {ɛ}_{i} - \text{?} ) Σ \frac{{N}_{i , j}}{\text{?} + {N}_{i , j} ( {ɛ}_{i} - \text{?} )}}$$

$$\text{?} \text{indicates text missing or illegible when filed}$$

where fᵢ is the volume fraction of the inclusions in the composite layer 22, ∈ₕ is the permittivity of the host (dielectric of the composite layer 22) and ∈ᵢ is the permittivity of the inclusions of the composite layer 22. For conductive inclusions, ∈ᵢ can be approximated to a pure imaginary number,

$${ɛ}_{i} = - \frac{{jσ}_{i}}{ω} .$$

The magnetic permeability of the microwires has little impact in the permeability of the composite material layer 22 and can be neglected for calculations.

For thin wires, such as microwires, for which the aspect ratio αᵣ is greater than 100,

$${N}_{x} = {N}_{y} = \frac{1}{2} ,$$

and

$${N}_{z} = {a}_{r}^{2} log ( \frac{1}{{a}_{r}} )$$

with

$${a}_{r} = \frac{d}{l} ,$$

being d the diameter and l the length of such microwires.

The microwire (inclusions in the composite layer 22) parameters are such that their volume fraction within the dielectric host material does not violate the percolation threshold and such that their aspect ratio (diameter/length) is comprised between 0.0004 and 0.2 (4-100 microns of diameter and 0.5-10 mm of length), more preferably between 0.003 and 0.007.

The number and width of layers 20 in the EM radiation attenuating material 10 of the invention is determined by the prediction model described in document WO 2010/029193 A1 belonging to the applicant and, in the case of paint being the dielectric material in both the dielectric layer 21 and in the composite layer 22, it is subjected to industrial painting schemes, so that the resulting paint retains the paint properties (adherence, colour, thixotropy, etc). To ensure that the resulting attenuating material 10 maintains the anticorrosion properties of the paint the protective layer of dielectric must be of at least 150 μm. For other type of dielectric materials, they are subjected to their industrial fabrication specifications. The thickness and number of layers 20, for all dielectric materials used, depend on the targeted frequency band to attenuate in the surface 30, and on the composite material used in the composite layer 22. Single band can be achieved with three layers 20 (Dielectric layer 21-Composite layer 22-Dielectric layer 21) and the total thickness of the EM radiation attenuating material 10 would typically go from 500 μm for the Ku band to 4 mm for the S band. Double band can be achieved with five layers 20 or more when frequencies are not harmonics or with two layers 20 when frequencies are harmonics, and, again depending on the frequency bands to absorb, the thickness varies: an X-Ku band absorber will typically have 2-3 mm, for non-harmonic double band absorption or considerably higher (6-7) when the double bands are harmonics.

When the host dielectric material in the composite layer 22 is a paint, any kind of paint (water base paints, oil base paints . . . ) can be used. The EM radiation attenuating material 10 is obtained with a painting scheme of layers of paint (as dielectric layer 21) and composite material (layer 22), where the composite is a mixture of the paint (dielectric host material) and microwires (inclusions). The type of paint can be different in each layer 20. The application of each layer 20 is usually defined by the manufacturer of the paint. The mixing of the paint with the microwires forming the composite layer 22 is such that the recommended manufacturer solvent, for oil based paints, and water, for water based paints, does not exceed a 20% in mass where the mixing velocity is lower than 2500 rpm. The resulting composite material can be applied with roller, air gun, an airless equipment or a HPLV, high pressure and low volume. The thickness of the composite material layer 22 can be controlled with a wet film gauge.

It is also important to note that composite materials maintain the non-functional properties of the dielectric host material (adherence, colour, thixotropy, etc.). Therefore, in the preferred embodiment of the invention, when the attenuating material 10 is a paint, it can be applied by means of a paint roller, an airgun or an airless equipment and the paint does not suffer degradation by adding the highly conductive fibres, preferably microwires.

In case of using a plastic material for the dielectric host material in the composite layer 22, if polyethylene is used, it can be rotomoulded or expanded.

Another embodiment of the invention consists of obtaining a wider band attenuation by means of multiple layers 20 such that the dielectric layers 21 are smoothly graded having different content of fibres, where the dielectric layer 21 having the highest content of fibres is the layer adjacent to the surface 30. Simulations show that such a smoothly graduated fibre content in a multiple layers 20 configuration is preferably achieved by 16 layers 20, each layer 20 preferably having a thickness of 1.6 mm, so that the total thickness of the EM radiation attenuating material 10 is preferably around 26 mm.

In yet another embodiment that provides wider band attenuation, the electromagnetic radiation attenuating material 10 comprises a first layer 20, located adjacent to the surface 30, multiple inner layers 20 and a last layer 20, used as a protective and finishing layer. The first and last layers 20 are layers 21 of dielectric material, whereas the multiple inner layers 20 are layers 22 of composite material having a decreasing fibre content, where the composite material layer 22 having the highest fibre content is the layer located adjacent to the first layer 20 of dielectric material and the composite material layer 22 having the lowest fibre content is the layer located adjacent to the last layer 20 of dielectric material.

In other words, each inner composite material layer 22 has a different fibre content, the inner composite material layers 22 are positioned consecutively based on the fibre content of each inner composite material layer 22, where the composite material layer 22 having the highest fibre content is the layer located adjacent to the first dielectric layer 21 and the composite material layer 22 having the lowest fibre content is the layer located adjacent to the last dielectric layer 21. Thus, the inner composite material layers 22 have a stepped decreasing fibre content.

Summarizing, some of the preferred possible embodiments covered by the present invention will be based on the following feature/characteristics variation of the layers 20, that is, based on the tuning of said layers 20:
Single band attenuation comprising two layers 20 plus a top coat layer 20 (protective layer): first dielectric material layer 21, extra coating layer 20 used for frequency tuning, composite layer 22 with microwires (inclusions) of certain parameters.
Double band attenuation comprising four layers 20 plus a top coat layer 20 (protective layer): first dielectric material layer 21, extra coating layer 20, composite layer 22 with microwires (inclusions), paint layer 20, composite layer 22 with microwires (inclusions).
Double band attenuation comprising two layers 20 of paint or of glass reinforced materials or plastic.
Multiple bands attenuation comprising multiple layers 20 that will be calculated depending on (as a function of) the number of frequencies (bands) to attenuate in the surface 30.

Thus, the parameters that are tailored (varied) in order to calculate different attenuation schemes by the EM radiation attenuating material 10 are the following:
thickness of layers 20 depending on tuning frequency/frequencies;
aspect ratio of microwires used as inclusions in the composite material layers 22;
volume fraction of microwires used as inclusions in the composite material layers 22.

Besides, the mixing process for mixing the dielectric host material and the inclusions forming the composite material layers 22 in the EM radiation attenuating material 10 can also vary and be tailored as to the following parameters: mixing velocity, time of mixing, maximum amount of microwires (inclusions) in the composite material layers 22, etc.

The process of applying the EM radiation attenuating material 10 obtained by the invention, when this material 10 is configured as a paint, can also be one of the following: roll, aerographic and air gun, each of these having different constrains.

The invention also provides a method of configuring an EM radiation attenuating material 10 able to reduce the electromagnetic incident radiation 100 as already described, depending on the parameters that can be tailored as a function of the attenuation sought, as it has already been described previously.

Furthermore, the use of the electromagnetic radiation attenuating material 10 according to the present invention is aimed to reduce the Radar Cross Section (RCS) of any structure 30 onto which it is applied, the structure 30 being a vehicle or a building. It can also be used as an isolation tool from EM GHz radiation. Since the electromagnetic radiation attenuating material 10 can be produced with different base materials (paint, GR, plastic) its use is rather diverse. For example, the EM radiation attenuating material 10 configured as a paint can be applied to any highly reflective surface 30, in the GHz spectrum, preferably to a metallic or metallized surface, such as a ship, vehicle or airplane, even buildings. Moreover, it could also be applied at specific locations near an emitting antenna to reduce the backscattered signal, or to isolate a chamber from in/out coming EM waves, in the S, C, X and Ku, frequency bands and any other situation where it is needed to reduce the reflection of EM waves. When the EM radiation attenuating material 10 is configured as GR (glass reinforced material) it can be incorporated in any structure 30 built with GR, i.e. wind turbines, airplanes, etc. But, it can also be used in similar scenarios as the paint, for chamber or antenna isolation, and in facades of airport buildings to reduce their impact in navigation and weather radars. The EM radiation attenuating material 10 being configured as a plastic (expanded or rotomoulded), the same applies, and any structure 30 built with plastic can be built with the electromagnetic radiation attenuating plastic material 10 such that their RCS is reduced. But also the plastic can be used for covering already built structures for EM isolation or RCS reduction.

Another embodiment of the invention develops an electromagnetic radiation attenuating material 10 comprising a layer 21 of a dielectric material (at least one layer 21), preferably a metallized (30) plastic material applied onto one side of the surface 21, such that the opposite side of the surface 21 comprises an electromagnetic radiation attenuating material 10 comprising a composite material layer 22 (at least one layer 22), this layer 22 comprising a mixture of a dielectric host material and inclusions, such that the dielectric host material is preferably a paint. In such a configuration, the RCS is reduced in the surface 10. The above-mentioned configuration also comprises a pair of top protective coats 20, one on the top of the surface 10 and the other on the metallized side of the surface 21. In the case mentioned, the thickness of the highly conductive layer 30, preferably metallized, of dielectric material is such that the low frequency radiation will be able to go through the surface 30, while the high frequency radiation will be absorbed by the attenuating material 10.

In other words, the electromagnetic radiation attenuating material 10 further comprises a metallized layer 30 located adjacent to the outer face of the first dielectric layer 21 in the material 10.

The low frequency electromagnetic radiation that will be able to go through the material 10 comprising said metallized layer 30 depends on the thickness of said metallized layer 30. If the thickness of the metallized layer 30 is less than the skin depth of the outgoing low frequency electromagnetic radiation, then said outgoing low frequency electromagnetic radiation will be able to go through the metallized layer 30 and the material 10.

Skin depth is a measure of how far electrical conduction takes place in a conductor prior to its complete attenuation. In other words, skin depth is the penetration distance of an electromagnetic wave in a conductor, such as a metal. The well-known equation for skin depth δ is given below:

$$δ = \sqrt{\frac{2 ρ}{2 π f μ}}$$

where ρ is the material resistivity, f is the frequency of the electromagnetic wave and μ the permeability of the material.

Therefore, the electromagnetic radiation attenuating material 10 absorbs incoming high frequency electromagnetic radiation but allows outgoing low frequency electromagnetic radiation to go through the material 10.

This embodiment is particularly useful when applied to antennas, where the thickness of the highly conductive layer 30, preferably metallized, is such that the antenna is able to transmit HF and VHF electromagnetic signals, though the reflection (of the covered antenna) of the incoming GHz electromagnetic radiation is reduced.

Summarizing, the electromagnetic radiation attenuating material 10 comes in different substrates, be it a paint, a GR or a plastic, and its use is focused to reduce the RCS of structures 30 or to isolate them from EM GHz radiation. The specific situation will determine which material would be used in each scenario.

Although the present invention has been fully described in connection with preferred embodiments, it is evident that modifications may be introduced within the scope thereof, not considering this as limited by these embodiments, but by the contents of the following claims.

1. Electromagnetic radiation attenuating material (10), applicable over a surface (30), comprising at least five layers (20), such that at least one of the layers (20) is a layer (21) comprising a dielectric material and at least one of the layers (20) is a layer (22) comprising a composite material, the layer (22) of composite material comprising a dielectric host material and inclusions embedded in said dielectric host material, characterized in that the first layer (20), located adjacent to the surface (30), and the last layer (20), used as a protective and finishing layer, in the material (10) are layers (21) of dielectric material, in that at least two of the inner layers (20) in the material (10) are layers (22) of composite material, in that the first and inner layers (20) in the material (10) are configured in such a way that the thickness and material composition of the first and inner layers (20), together with the number and positioning order of the inner layers (20) as well as the aspect ratio and volume fraction of the inclusions in the layer (22) of composite material, determine the frequency hands in which the electromagnetic radiation reflected by the surface (30) is attenuated with respect to the incident electromagnetic radiation (100) on said surface (30), and in that the inclusions embedded in the dielectric host material are highly conductive fibres.

2. Electromagnetic radiation attenuating material (10) according to claim 1 wherein the inner layers (20) are composite material layers (22) having a decreasing fibre content, where the composite material layer (22) having the highest fibre content is the layer adjacent to the first layer (20) in the material (10) and the composite material layer (22) having the lowest fibre content is the layer adjacent to the last layer (20) in the material (10).

3. Electromagnetic radiation attenuating material (10) according to claim 1, wherein the dielectric material forming the dielectric lasers (21) and the dielectric host material in the composite material layers (22) is the same material.

4. Electromagnetic radiation attenuating material (10) according to claim 3 wherein the material of the dielectric layers (21) and of the composite layers (22) is one of the following: paint, glass reinforced materials, polyethylene, polyester or elastomeric materials.

5. Electromagnetic radiation attenuating material (10) according to claim 3, wherein the permittivity of the material forming the dielectric layers (21) and the dielectric host material in the composite material layers (22) is comprised between 1 and 10, the permeability of this material being around 1.

6. Electromagnetic radiation attenuating material (10) according to claim 1, wherein the highly conductive fibres in the composite material layers (22) are metallic microwires.

7. Electromagnetic radiation attenuating material (10) according to claim 1, further comprising a metallized layer (30) located adjacent to the outer face of the first laser (20) in the material (10), wherein the thickness of the metallized layer (30) is less than the skin depth of an outgoing low frequency electromagnetic radiation that is able to go through the material (10).

8. Electromagnetic radiation attenuating material (10) according to claim 7 wherein the dielectric host material is a paint.

9. Electromagnetic radiation attenuating material (10) according to claim 7 also comprising a protective coat (20) on the top of the metallized layer (30).

10. Method for configuring the electromagnetic attenuating properties of an electromagnetic radiation attenuating material (10), applicable over a surface (30), according to claim 1, the method determining the thickness and material composition of the first and inner layers (20), together with the number and positioning order of the inner layers (20), also determining the aspect ratio and volume fraction of the inclusions in the layers (22) of composite material as a function of the frequency bands in which the electromagnetic radiation reflected by the surface (30) is required to be attenuated with respect to the incident electromagnetic radiation (100) on said surface (30).

11. Method according to claim 10, wherein the material of the dielectric layers (21) and of the composite layers (22) is a paint, the method configuring the layers (20) in the paint in such a way that the solvent or water does not exceed a 20% in mass, when the mixing velocity is lower than 2500 rpm.

12. Method according to claim 10, wherein the mixing the dielectric host material and the inclusions forming the composite material layers (22) in the electromagnetic radiation attenuating material (10) is controlled as a function of the mixing velocity, the time of mixing and the maximum amount of inclusions in the composite material layers (22), among others.

13. Electromagnetic radiation attenuating material (10) according to claim 1, wherein the composite material layers (22) and the dielectric layers (21) can be applied over large surfaces with usual industrial techniques, like airless, HVLP, roller, etc.

14. Electromagnetic radiation attenuating material (10) according to claim 1, the electromagnetic radiation attenuating material (10) being a paint and wherein the total scheme maintains the paint original properties, like adhesion, anticorrosion, colour, thixotropy, etc.
